(19) United States
(12) Patent Application Publication
(10) Pub. No.: US 2014/0278150 A1
(43) Pub. Date: Sep. 18, 2014

(54) UTILITY POLE CONDITION SENSORS

(71) Applicant: COOPER TECHNOLOGIES COMPANY, Houston, TX (US)

(72) Inventors: Perry Baesler, Maple Grove, MN (US); Matt Fisher, Brooklyn Center, MN (US); Steve Junod, Dubuque, IA (US); Garrett DeZeeuw, Otsego, MN (US)

(21) Appl. No.: 14/212,915

(22) Filed: Mar. 14, 2014

Related U.S. Application Data
(60) Provisional application No. 61/781,817, filed on Mar. 14, 2013.

(51) Int. Cl. G01N 35/00

(52) U.S. Cl. CPC G01N 35/00
USPC 702/34

(57) ABSTRACT

An apparatus and methods involved in the process of assessing utility pole condition and, in particular, the apparatus and methods involved in the use of sensors to assess utility pole fatigue in response to age, weather, wear, impact and other potential damage events. A utility pole sensor system is provided for rapidly and efficiently assessing utility pole fatigue in response to passively induced environmental movements prior to a natural or man-made failure of the utility pole.

### RELATED APPLICATION

The present application claims the benefit of U.S. Provisional Application No. 61/781,817 filed Mar. 14, 2013, which is incorporated herein in its entirety by reference.

### FIELD OF THE INVENTION

The invention relates generally to the materials and methods involved in the process of assessing utility pole condition and, in particular, the materials and methods involved in the use of sensors to assess utility pole fatigue in response to age, weather, wear, impact, fire, insects, pests, fungi, bacteria, and other potential damage events.

### BACKGROUND OF THE INVENTION

The rapid and efficient distribution of public utilities is essential for the operation of modern homes and businesses, and utility poles are a necessary part of the infrastructure supporting these public utilities. They facilitate the efficient transfer of public utilities across long distances by providing support for power lines, cable, fiber optic cable, and related equipment such as transformers. Generally, utility poles are made of wood, pressure-treated with a preservative for protection against rot, fungi, and insects; however, they are also made of other materials, including steel and concrete, or composites, like fiberglass. The wires, cables, and power lines supported by utility poles are typically attached to the top portion of the pole at a safe distance from people, cars, and buildings. In residential areas, for example, the minimum height for power lines carrying less than 200 volts is 12 feet, and for power lines carrying over 300 volts, the minimum distance is 15 feet.

Given their importance for the rapid and efficient transfer of public utilities, utility poles demand regular maintenance and replacement. In addition to normal degradation due to age and environmental processes, utility poles are vulnerable to both natural disasters (e.g., storms, hurricanes, earthquakes, fires, etc.), as well as man-made disasters (e.g., car accidents, vandalism, terrorism, etc.). If a utility pole collapses due to wear, weather or an accident, it needs to be replaced immediately, or there will be a disruption in the delivery of certain public utilities. Therefore, it would be advantageous to be able to monitor and determine in advance the degree of utility pole fatigue, such that potentially weak utility poles that may be more prone to failure can be replaced or repaired before collapsing and causing a disruption in service.

Traditionally, utility pole inspections have been manual processes where a visual inspection identifies suspected poles that may require further manual testing in response to an induced test signal such as a hammer strike or concussion as shown, for example, in U.S. Pat. No. 5,105,453 and European Patent Nos. EP1943497 and EP2350637. U.S. Patent Publication No. 2011/0288777, entitled “System, Device, and Method for Automatic Detection and Reporting of Location and Extent of Service Failure in Utility and Telecommunication Networks,” offers one example of obtaining the operational condition information of individual utility poles using a sensing device that obtains operational condition information, which may include temperature, position, vibration, and electromagnetic field (EMF). This system determines whether the measured values are outside a predetermined threshold and reports the location of the utility pole. Unfortunately, this system does not assess the degree of utility pole fatigue or damage or how such fatigue or damage may change over time. Therefore, there is a need for better systems and methods for assessing utility pole condition by rapidly and efficiently assessing utility pole fatigue prior to a natural or man-made disaster.

### SUMMARY OF THE INVENTION

Embodiments of the present invention are directed to methods and apparatus for utilizing a utility pole sensor system that assesses the condition of a utility pole by assessing the effects of passively induced movements and vibrations of the utility pole. Unlike systems that measure the movements of a utility pole in response to forces actively applied to the pole by, for example, striking the pole, embodiments of the utility pole sensor system in accordance with the present invention rely on sensing and measurement of passively induced movements and vibrations of the utility pole as may be caused, for example, in response to the forces of air and/or ground movements and/or environmental changes to mechanical loading as caused, for example, by ice storms.

In one aspect, the utility pole sensor system can comprise an accelerometer, wherein the accelerometer can be configured to measure movement in the utility pole, in particular, wind-induced movement in the utility pole or other movements passively induced in response to environmental forces or actions. In another aspect, the utility pole sensor can comprise a velocimeter, wherein the velocimeter can be configured to measure the wind speed affecting the pole. The data generated by an accelerometer or a velocimeter can then be used to assess utility pole condition by correlating the amount of wind-induced movement exhibited by the pole, or by correlating the amount and speed of the wind affecting the pole, with the degree of fatigue exhibited by the pole. In another aspect, the utility pole sensor can comprise a sensor specifically for detecting ground-induced movements affecting a utility pole. In another aspect, the utility pole sensor can comprise an acoustic sensor or an infrared sensor, wherein the acoustic or infrared sensor can be configured to assess whether the utility pole has been tampered with or accessed by unauthorized personnel. The infrared sensor can also be configured to detect wild fires in remote locations, or other fires in close proximity to the utility pole.

The utility pole sensor system can also comprise a controller and a memory, wherein the controller communicates the sensor data (e.g., the quantification of one or more variables affecting the condition of the utility pole) to a separate device. In one aspect, the controller analyzes the sensor data and either communicates it to a remote device, or stores it in a memory for communicating to a remote device at some time in the future. Generally, the utility pole sensor system can be installed in the utility pole as part of the manufacturing process, or it can be added to a utility pole after it has been implanted in the ground.

Over time, the sensor data can reflect a change in a one or more variables affecting utility pole condition. In one aspect, an accelerometer can measure the wind-induced movement exhibited by the utility pole, such that the movement and/or resonance of the utility pole changes over time. In another aspect, a velocimeter can measure the wind speed affecting the utility pole, such that the wind speed and direction can be compared to any wind-induced movement and/or resonance in the utility pole that changes with changes in wind speed. In some aspects, the sensor data from the accelerometer and the velocimeter can be correlated and used to assess the utility pole fatigue. Generally, the more a utility pole is exposed to high velocity winds, the more it will be subjected to stress, and this stress caused by wind-induced movement can exacerbate pole fatigue. In some aspects, these sensor data can indicate a need for a manual inspection of the utility pole in order to verify whether the degree of fatigue indicates a need for the pole to be repaired or replaced.

When utility pole sensor systems are placed on a plurality of utility poles, the controllers can communicate a plurality of sensor data to a remote device, wherein the remote device can analyze the plurality of sensor data. In one aspect, the remote device can use the plurality of sensor data to generate an algorithm, wherein the algorithm can establish a correlation between one or more variables and utility pole fatigue. For example, the algorithm can be used to correlate wind-induced movement with utility pole fatigue. The extent or degree of utility pole fatigue can be verified in an individual pole by manual inspection, and this information can also be input into the algorithm. After sufficient data acquisition and analysis, the algorithm can be used to assess whether there is a need for manual inspection of an individual pole to verify whether the degree of fatigue indicates a need for the pole to be repaired or replaced. In this manner, the controller can communicate to a remote device that a certain action should be taken in response to the assessment of an individual utility pole. This action can be an alarm, indicating a need to take immediate action to replace or repair the utility pole, or it can be in the form of a request for a manual inspection to update the utility pole's condition. In another aspect, the controller can communicate to a remote device that the utility pole has been tampered with, shot at, accessed by unauthorized personnel, or threatened by fire, as indicated by the acoustic or infrared sensor. In another aspect, the controller can be configured to automatically communicate the sensor data to a remote device. This automatic communication can be done at pre-set periodic intervals, or it can be done in real time. The controller can also be configured to automatically store the sensor data in the memory, wherein it can be retrieved at some time in the future. In addition to communicating sensor data, the controller can be configured to communicate other information, including GPS coordinates, temperature, humidity, barometric pressure, battery status, etc. The remote device to which the controller communicates the sensor data can include a remote server, a computer, or a remote monitoring device. In some aspects, the sensor data can be retrieved from the controller or the memory using a wireless communication device, such as a radio frequency identification device.

The power required to operate the utility pole sensor can be drawn from a portable or detachable battery operably coupled to the sensor. In some cases, the battery can also be rechargeable. In other aspects, the power can be drawn from the transformer located on the utility pole. In still other aspects, the power can be generated by a device that uses wind flow or solar energy to generate electricity. In still other embodiments, power for the utility pole sensor may be harvested from the power lines.

In various embodiments, the utility pole sensor may be a standalone unit, or the utility pole sensor may be packaged together with other pole-mounted equipment (e.g., protection equipment, transformers, or regulators) and mounted only on poles with this extra equipment mounted on the utility pole in order to provide better sensing of potential failure of those utility poles with equipment mounted on the poles that will be heavier, but also more important to protect and more expensive to replace should they fail.

In other embodiments, the utility pole sensor may be coupled together with a radio unit that can provide for radio mesh-networking, both to communicate sensed information and to provide a mesh-networking backbone that may be communicatively coupled with various other utility sensing and communication devices, such as residential meters, load control receivers, radio frequency relays, and radio frequency gateways.

Data collected by the sensor could also be used by a remote application and algorithm to provide reports of utility pole conditions, charting data on a graph to visually represent the trend of deterioration of the utility pole, real-time notifications could be sent out in various forms such as telephone voice or data calls, text messages, SMS messages, and over social media to alert operators, reports from law enforcement or other interested parties of tampering, vandalism or of fires within close proximity to the utility pole.

In some embodiments, the remote application may include a utility monitoring system, such as the Yukon application available from the assignee of the present application, which may be configured to report out issues based on utility pole sensed data surpassing a configurable threshold could trigger an alarm in real-time to immediately alert an operator in a control room. In various embodiments, the Yukon application is able to display the data collected on a graph in real-time. The Yukon application may also be configured to display an audible and visual alarm in the application when a configurable threshold was exceeded. In various embodiments, there can be an ability to store the utility pole sensor data collected in a Yukon database for reporting, analysis and trending purposes either in real-time or historically. These trends and the data may be used to identify those poles that are most likely to fail based on data from all the poles being monitored. Utility poles reporting with the most vibration may indicate which poles have the most deterioration and warrant further manual inspection. The Yukon application can be configured to provide the analysis algorithm, reporting, alarms, notifications and trending graphs of the data in either real-time or historically. In another embodiment, an infrared sensor detecting wild fire in a remote location could send a notification (phone call, text message, or SMS message) to the rural fire department, law enforcement and a remote operator monitoring the system. An alarm could also be sounded to notify the operator that is monitoring the Yukon application. Messages could also be distributed via social media. In an alternative embodiment of this usage, various tamper or sabotage detection could notify the local utility and law enforcement and generate reports similar to the wild fire reports.

### BRIEF DESCRIPTION OF THE DRAWINGS

The invention can be more completely understood in consideration of the following detailed description of various embodiments of the invention in connection with the accompanying drawings, in which:

FIG. 1 is a block diagram of a utility pole sensor system.

FIG. 2 is a diagram of the method of sensing and collecting sensor data from a plurality of utility poles and correlating that data with the data generated from the manual inspection of the degree of fatigue in a plurality of utility poles.

FIG. 3 is a diagram of the method of assessing utility pole fatigue without the need for prior manual inspection using an algorithm that correlates the degree of utility pole fatigue with the sensor data generated by the utility pole sensor system.

While the invention is amenable to various modifications and alternative forms, specifics thereof have been shown by way of example in the drawings and will be described in detail. It should be understood, however, that the intention is not to limit the invention to the particular embodiments as described. On the contrary, the intention is to cover all modifications, equivalents, and alternatives falling within the spirit and scope of the invention as defined by the appended claims.

### DETAILED DESCRIPTION OF THE DRAWINGS

As depicted in FIG. 1, the utility pole sensor system 100 of the present invention generally comprises a controller 110 that receives data that is sensed and collected by the sensor 120. This sensor data relates to the measurement or quantification of a variable 170 affecting utility pole condition. For example, variables affecting utility pole condition can include the age of the utility pole or the material of which it is constructed. The variables affecting utility pole condition can also be related to weather or natural disasters (e.g., wind exposure, wind-induced movement, earth-induced movement, precipitation, fires, etc.), or they can be man-made variables (e.g., unauthorized tampering, vandalism, terrorism). In general, the more a utility pole is exposed to such variables, the more its condition deteriorates.

Once the sensor 120 senses or detects a variable or variables affecting utility pole condition, it can send the data to the controller 110 to be further processed or analyzed. In some embodiments, the controller 110 will send the sensor data to the memory 130 to be stored and subsequently communicated back to the controller 110 at some periodic points in the future. In some embodiments, the controller 110 will analyze the sensor data from the sensor 120 immediately upon receiving it, such that the data can be communicated in the form of a recommended action to be taken in response to the sensor data. In some embodiments, the controller 110 can communicate the sensor data to a remote device 140 for processing or analysis, such that the data can then be communicated in the form of a recommended action to be taken in response to the sensor data. The controller 110 can also send the sensor data, and optionally receive parameters and configuration data, via the transmission line 150 of the utility pole. In addition to communicating sensor data, the controller can be configured to communicate other information, including GPS coordinates, temperature, humidity, barometric pressure, battery status, etc.

The data measured and collected by the sensor 120 can be used to assess a specific operational condition of a utility pole. For example, in one embodiment, the sensor 120 can be an accelerometer configured to measure the movement or vibrations of the utility pole that can affect the degree of fatigue of the pole. The vibrations or movement can be caused, for example by the wind (i.e., wind-induced movement) and/or the earth (i.e., earthquakes). Generally, the more the utility pole experiences movement induced stresses or vibrations, the greater the degree of fatigue. In some embodiments, the sensor data provided by the accelerometer can be sent to the controller 110 to be processed or analyzed, or it can be processed and analyzed in a remote device. This analysis can be such that it can indicate a need to take a recommended action based on the degree of movement sensed and measured by the accelerometer. The analysis can recommend that the action be complete removal and replacement of the utility pole (i.e., high degree of fatigue), it can indicate that the pole needs to be repaired, or it can indicate the need for a manual inspection. In some embodiments, the sensor 120 can comprise many different instruments for assessing the variables affecting utility pole condition, including, but not limited to, accelerometers, velocimeters, thermometers, gyroscopes, barometers, and moisture content sensors.

Additionally, as illustrated in FIG. 1, the utility pole sensor system can, in certain embodiments, comprise a power source 160 from which the utility pole sensor 100 will draw power during its operation. In some embodiments, the power source 160 can be a portable or detachable battery that is easily replaced. In some embodiments, the battery can also be rechargeable. In other embodiments, the power to recharge the battery and power the system can be drawn from the transformer located on the utility pole, or by harvesting power from a power line, or the power can be generated by a device that uses wind flow or solar energy to generate power.

As depicted in FIG. 2, the utility pole sensor system 100 of an embodiment of the present invention generally comprises a method of sensing and collecting sensor data from a plurality of utility poles and correlating that data with the data generated from the manual inspection 200 of a plurality of utility poles. When utility pole sensors 100 are placed on a plurality of utility poles, the data generated from the sensors can be correlated or compared to data generated from a manual inspection 200 of the same set of a plurality of utility poles. In some embodiments, the sensors 120 of the utility pole sensor systems 100 can comprise accelerometers that sense and measure the vibrations or movement of the utility poles. This plurality of sensor data can be communicated to a remote device 140, along with the data corresponding to the degree of utility pole fatigue as indicated by manual inspection 200.

As illustrated in FIG. 3, the utility pole sensor system 100 of the present invention generally comprises a method of assessing utility pole fatigue without the need for prior manual inspection using an algorithm that correlates the degree of utility pole fatigue with the sensor data generated by the utility pole sensor system. For example, in an embodiment, the sensors 120 of the utility pole sensor systems 100 can comprise accelerometers that sense and measure the vibrations or movement of the utility poles. This plurality of sensor data can be communicated to a remote device 140, along with the data corresponding to the degree of utility pole fatigue, as indicated by manual inspection 200. The remote device 140 can then use the accelerometer data and the manual inspection data to create an algorithm that can be predictive of the degree of fatigue of an individual utility pole, without the need for a manual inspection. In this manner, the utility pole sensor system 100 can indicate that a recommended action be taken, including replacement or repair of a utility pole, or whether a utility pole needs an updated manual inspection.

In some embodiments, the sensor data can comprise measurements corresponding to a plurality of variables affecting utility pole fatigue or condition, such that its predictive accuracy can be enhanced. In some embodiments, information corresponding to the age, composition, and construction of an individual utility pole, and the type of soil in which the utility pole is installed can be considered in the assessment of utility pole fatigue, such that its predictive accuracy can be enhanced. In this manner, the utility pole sensor system 100 can significantly decrease the labor and cost involved in assessing utility pole fatigue in a plurality of utility poles. For example, manual inspections performed when the sensor is installed could also be used to identify the type of soil in which the utility pole is installed, such as sand or clay. This would provide additional information that could be used by the algorithm to help evaluate and predict rates of decay and help set the vibration thresholds.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

Where the term “configured to” is included in the specification or the claims, it is understood that the term is means that the feature is constructed to, programmed to, or otherwise tuned, calibrated, or adjusted to have the necessary structures and algorithms to perform the stated operation.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A utility pole sensor system for assessing utility pole condition, wherein the utility pole sensor system is configured to couple to a utility pole, and wherein the utility pole sensor system comprises:
a sensor configured to collect sensor data relating to a variable affecting the utility pole;
a controller operably connected to the sensor and configured to receive the collected sensor data; and
a memory operably connected to the controller and configured to store the collected sensor data.

2. The utility pole sensor system according to claim 1, further comprising an accelerometer configured to assess wind-induced movement in the utility pole.

3. The utility pole sensor system according to claim 1, further comprising a velocimeter configured to assess wind speed affecting the utility pole.

4. The utility pole sensor system according to claim 1, further comprising an acoustic sensor.

5. The utility pole sensor system according to claim 1, further comprising an infrared sensor.

6. A method for assessing utility pole condition using the utility pole sensor system of claim 1, comprising:
placing utility pole sensor systems on a plurality of utility poles;
sensing a variable affecting each one of the plurality of utility poles and collecting sensor data from each of the plurality of utility poles relating to this variable;
analyzing the sensor data collected from the plurality of utility poles using the controller or a remote device; and
communicating a recommended action based on the analysis of the sensor data.

7. The method of claim 6, wherein the sensor data comprises data relating to nature induced movement of the utility pole.

8. The method of claim 6, wherein the sensor data comprises data relating to tampering with the utility pole.

9. The method of claim 6, wherein the sensor data comprises data relating to fire detection within proximity of the utility pole.

10. The method of claim 6, wherein the remote device is a server, computer, or monitoring device.

11. The method of claim 6, wherein the remote device is a software application that provides data reporting.

12. The method of claim 6, wherein the remote device is a software application that provides data analysis.

13. The method of claim 6, wherein the remote device is a software application that provides notifications by telephone, SMS message, text message, a message displayed to an operator, a message distributed on social media, or a combination thereof.

14. The method of claim 6, wherein the remote device is a software application that provides an audible alarm, a visual alarm, or both to the operator.

15. The method of claim 6, wherein the recommended action is selected from the group consisting of to replace or repair the utility pole, to update the condition of the utility pole using manual inspection, to alert law enforcement regarding real-time tampering or vandalism of the utility pole, to alert authorities regarding a possible fire danger to the utility pole or surrounding area, and combinations thereof.

16. The method of claim 6, wherein the method further comprises manually inspecting a plurality of utility poles and obtaining data relating to a degree of utility pole fatigue and correlating this data with the sensor data.

17. The method of claim 6, wherein the analysis of the sensor data is performed by the controller.

18. The method of claim 6, wherein the analysis of the sensor data is performed by the remote device.

19. The method of claim 6, wherein the sensor data is stored in the memory.
